(19) United States
(12) Patent Application Publication
(10) Pub. No.: US 2023/0401593 A1
(43) Pub. Date: Dec. 14, 2023

(54) LEASING DIGITAL ASSETS

(71) Applicant: International Business Machines Corporation, Armonk, NY (US)

(72) Inventors: Aaron K. Baughman, Cary, NC (US); Shikhar Kwatra, San Jose, CA (US); Kavitha Hassan Yogaraj, Bangalore (IN); Vinod A. Valecha, Pune (IN); Tiberiu Suto, Franklin, NY (US)

(73) Assignee: International Business Machines Corporation, Armonk, NY (US)

(21) Appl. No.: 17/747,141

(22) Filed: May 18, 2022

(51) Int. Cl. G06Q 30/02; G06Q 30/06; G06Q 20/12

(52) U.S. Cl. CPC G06Q 30/0206; G06Q 20/1235; G06Q 30/0645; G06Q 30/0201

(57) ABSTRACT

A price for use of a digital asset in a set of digital assets is determined. The set of digital assets stored in a digital asset repository. A time slot during which the digital asset is available for use is determined. The digital asset is leased out at the price and during the time slot, the leasing allowing use of the digital asset during the time slot in return for payment of the price. the leased digital asset is integrated with a set of base characteristics of a virtualized user. The integrated leased digital asset is presented in a virtual environment during the time slot.

### BACKGROUND

The present invention relates generally to a method, system, and computer program product for digital asset management. More particularly, the present invention relates to a method, system, and computer program product for leasing digital assets.

A digital asset comprises both an item that exists in a digital format and the right to use the item. Some examples of digital assets are digital images, logos, illustrations, animations, songs and other audio recordings, videos, presentations, spreadsheets, text documents, and virtual goods used in electronic games, augmented reality (in which objects that exist in the real world are combined with computer-generated perceptual information), virtual reality (a simulated experience that can be similar to, or different from, the real world), and other virtualized environments. For example, similar to purchasing a digital version of a song to listen to or a digital version of a movie to watch, a user of a fantasy game might purchase a magic sword for his or her character to use while playing the game, or trade real-world currency for in-game currency such as virtual gold pieces. As another example, a user of a virtualized basketball game might purchase virtual items of clothing, such as a shirt or shoes, for his or her character to wear while playing the game.

An avatar is a representation of a user in a virtualized environment. Some users select avatars that share visual characteristics or abilities with the user, while others do not. For example, an attendee at a virtualized technical conference might use, as her avatar, a digital image of her actual face, while a player of a fantasy game might use, as his avatar, a unicorn. Thus, an avatar, or a feature of an avatar, can also be a digital asset.

A non-fungible token (NFT) is a unit of data stored on a blockchain, a form of digital ledger. An NFT can be used to denote the right to use a digital asset associated with the NFT. Because NFTs are unique, they can be used to limit the number of copies available of a digital asset. For example, an artist may wish to create a limited edition of an image by creating only ten copies of the image, thus increasing the perceived value of each copy. An NFT (and, if applicable, an associated right to use, copy, or display the underlying asset) can be traded and sold. Although NFTs can be helpful in buying and selling digital assets, digital assets need not be traded using NFTs.

### SUMMARY

The illustrative embodiments provide a method, system, and computer program product. An embodiment includes a method that determines a price for use of a digital asset in a set of digital assets, the set of digital assets stored in a digital asset repository. An embodiment determines a time slot during which the digital asset is available for use. An embodiment leases out, at the price and during the time slot, the digital asset, the leasing allowing use of the digital asset during the time slot in return for payment of the price, the leasing resulting in a leased digital asset. An embodiment integrates, with a set of base characteristics of a virtualized user, the leased digital asset, the integrating resulting in an integrated leased digital asset. An embodiment presents, in a virtual environment during the time slot, the integrated leased digital asset

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for leasing digital assets in accordance with an illustrative embodiment;

FIG. 4 depicts an example of leasing digital assets in accordance with an illustrative embodiment;

FIG. 5 depicts a continued example of leasing digital assets in accordance with an illustrative embodiment;

FIG. 6 depicts a continued example of leasing digital assets in accordance with an illustrative embodiment;

FIG. 7 depicts a continued example of leasing digital assets in accordance with an illustrative embodiment;

FIG. 8 depicts a continued example of leasing digital assets in accordance with an illustrative embodiment;

FIG. 9 depicts a flowchart of an example process for leasing digital assets in accordance with an illustrative embodiment;

FIG. 10 depicts a cloud computing environment according to an embodiment of the present invention; and

FIG. 11 depicts abstraction model layers according to an embodiment of the present invention.

### DETAILED DESCRIPTION

The illustrative embodiments recognize that, while digital assets can be bought and sold, a user may have only a temporary need for a digital asset, and thus not want to purchase the asset. For example, a user might want to virtually wear a shirt depicting a rock band, but only while virtually attending that band's concert. Another example user might want to virtually wear a suit for a virtual job interview, but not for ordinary work meetings. Thus, the illustrative embodiments recognize that there is a need to provide a temporary right to use a digital asset—in other words, a lease of the asset. A lease is a contract by which one party conveys an asset to another for a specified time, usually in return for a one-time or periodic payment. However, payment is not required to form a lease.

The illustrative embodiments also recognize that, while most digital assets are in visual or audio form, digital assets need not be limited to these forms. A digital asset can also be a behavior, skill, or ability, such as the ability to run faster or jump higher than a baseline ability in a virtualized sports game. Thus, the illustrative embodiments recognize that there is also a need to provide a lease option for digital behaviors, skills, or abilities, to accommodate users who might want to use one of these digital assets for a limited time period or a special occasion.

The illustrative embodiments also recognize that the availability of digital assets can be limited, and thus their value increased, by implementing digital assets as NFTs. For example, a fashion designer might want to increase the perceived value of her virtual fashions by specifying that only one copy of a virtual garment be available for virtual wearing at a time. However, the market for outright purchase of such digital assets is small, and thus the designer might realize increased profit by making the virtual garment available on a lease basis, similar to the real-world renting of formalwear for special occasions. Thus, the illustrative embodiments recognize that there is a need for an NFT implementation that supports leasing, rather than purchasing, NFTs.

The illustrative embodiments recognize that the presently available tools or solutions do not address these needs or provide adequate solutions for these needs. The illustrative embodiments used to describe the invention generally address and solve the above-described problems and other problems related to leasing digital assets.

An embodiment can be implemented as a software application. The application implementing an embodiment can be configured as a modification of an existing digital asset management system, as a separate application that operates in conjunction with an existing digital asset management system, a standalone application, or some combination thereof.

Particularly, some illustrative embodiments provide a method that determines a price for use of a digital asset, determines a time slot during which the digital asset is available for use, leases out the digital asset at the price and during the time slot, integrates the leased digital asset with a set of base characteristics of a virtualized user, and presents the integrated leased digital asset in a virtual environment during the time slot.

An embodiment manages a set of digital assets in a digital asset repository. Each digital asset includes the asset itself, as well as metadata pertaining to the asset. Some non-limiting examples of metadata pertaining to the asset are a lease or purchase price of the asset, a time period during which the asset is available for lease, a time period during which the asset is leased out and thus not available to others, data identifying an authorized user of the asset, how many copies of the asset exist, and contextual data describing a context in which the asset is to be used (e.g. data describing a technical conference at which the asset is to be virtually worn, or data identifying an electronic game in which the asset is to be used). An embodiment also manages transactions involving one or more digital assets in the digital asset repository, including transferring assets between users, transferring assets to another system external to the embodiment, creating, modifying, creating additional copies of, and deleting digital assets, and optionally performing payment processing for transactions involving managed digital assets. One embodiment modifies digital assets by combining multiple assets. For example, a virtual shirt and virtual pants can be combined into one virtual outfit. Another embodiment modifies digital assets by combining parts of multiple assets. For example, the virtual shirt within the virtual outfit can be combined with a virtual logo that is part of another virtual asset to create a new virtual shirt including the logo. Techniques for combining images, such as generative adversarial networks, are presently available. One embodiment manages the set of digital assets using an NFT corresponding to each asset, and stores transaction data associated with an NFT on a blockchain.

An embodiment also manages one or more user profiles in a user profile repository. A user profile includes a user's wallet, which includes data of the digital assets a user currently has access to, as well as data identifying the user. The digital assets a user currently has access to include any assets a user has purchased, any assets a user has leased (along with an expiration time of the lease), and any assets a user has fractional ownership of (along with the amount of fractional ownership). The user profile also includes optional additional data. One non-limiting example of data stored in a user profile is a history of digital assets the user has leased or purchased in the past, along with price data and usage times for each. Other non-limiting examples of data stored in a user profile are visual representation data (for use in integrating the user's visual representation with a digital asset), avatar data (for use in integrating the user's avatar with a digital asset), baseline skill, behavior, or ability data for the user or a character the user plays in a game or simulation, calendar or event data (for use in determining the user's upcoming events and which digital asset the user might be interested in using at an event), social media data (for use in determining the user's interests and events), payment data (for use in processing payment for a digital asset, accessory data (items the user was wearing or using in real-world or simulated interactions with others, used in determining the user's interests), and the like. For example, to generate three-dimensional visual representation data of a user, one presently available technique generates a three-dimensional scan from two-dimensional images of the user, generates a set of polygons corresponding to the three-dimensional scan, optimizes the set of polygons for implementation in a particular environment (based on processor speed, screen size, and the like), and adds texture detail. Presently available motion capture techniques are also usable to capture motions of the user, for use in animating a virtual version of the user.

An embodiment determines a price for use of a digital asset in the digital asset repository. In one embodiment, a price for use of a digital asset is predetermined. For example, in a fantasy game some digital assets might be free once a user has reached a predetermined level of the game, some virtual assets depicting virtual clothing might be priced at one dollar per day, and the only magic sword available in the game might be priced at a hundred dollars per hour of usage. Another embodiment uses a regression model, to predict a future price for use of a digital asset. A regression model estimates relationships between a dependent, output variable (here, a predicted price) and one or more independent, input variables. Some non-limiting examples of input variables are previous prices for digital assets, asset advertising data, promotions and other purchase or lease incentives on an asset, and contextual data of an asset. Contextual data of an asset is data regarding something else the asset is based on. For example, one digital asset in a virtual basketball game might be the virtual shirt of a real player in a real basketball league on which the virtual basketball game is based. The price of the virtual shirt can be expected to vary based on the real-world popularity of the real player. Depending on the input variables, an appropriate level of data aggregation by time (e.g. using weekly, monthly, or quarterly) data and geography (e.g., a particular region or country) is selected for use in the regression model. Techniques for using a regression model to predict a future price of an asset using a set of input variables are presently known. Other techniques to predict a future price of an asset using a set of input variables are also possible and contemplated within the scope of the illustrative embodiments.

An embodiment determines a time slot during which the digital asset is available for use. One embodiment assigns time slots on a first-come, first served basis. In other words, the first user to request use of an asset gets the asset for a predetermined time period, or a requested time period, while other users who want to lease the asset must select different times or wait until the first user's lease has expired. Another embodiment attempts to optimize multiple users' use of a digital asset by treating asset scheduling as a Traveling Salesman Problem with Time Windows (TSPTW) problem. TSPTW finds a minimum-cost path that visits each of a set of cities exactly once, where each city must be visited within a predetermined time window. If the set of cities represents a set of users who want to use a digital asset and time windows impose time constraints that a feasible solution must satisfy, the resulting path represents a time schedule for asset usage, with time slots for each user's asset lease. Techniques for solving TSPTW, using both classical computing and quantum computing (by implementing the problem as a quadratic unconstrained binary optimization (QUBO) problem and solving the QUBO problem using a quantum computer), are presently available.

An embodiment recommends a digital asset to a user for lease or purchase. In one embodiment, the recommendation includes a price for the asset. In another embodiment, the recommendation includes a time slot during which the asset is available. In another embodiment, the recommendation includes both a time slot and a price for leasing the asset during the time slot. One embodiment recommends one or more digital assets in response to a search query, such as a query for a virtual shirt with a particular logo or an ability to run in a virtual environment faster than a baseline speed.

Another embodiment recommends one or more digital assets using a collaborative filtering technique, which identifies a set of other users with one or more characteristics having more than a threshold amount of similarity with the user for whom an asset is being recommended, determines which assets the set of other users has purchased or leased, and uses characteristics of those assets to produce a set of recommended assets, or a ranked set of recommended assets, for the user. Collaborative filtering techniques are presently available.

Another embodiment recommends one or more digital assets using a content-based recommender system, which identifies characteristics of a user's past purchases or leases of digital assets, identifies one or more digital assets with characteristics above a threshold amount of similarity to the user's past purchases or leases, and uses those similarities to recommend a set of digital assets, or a ranked set of digital assets, to the user. To determine asset similarity, embodiments use presently known analysis techniques such as image to text decoding, term frequency, and inverse document frequency to determine an embedding corresponding to an asset. An asset embedding is a vector (a multidimensional numerical representation) of a set of characteristics of the asset, in which asset similarity can be determined by computing a distance between vectors (e.g., a cosine similarity) corresponding to each asset. To determine user similarity, embodiments use presently known techniques, including term frequency, and inverse document frequency to determine an embedding corresponding to a user. A user embedding is a vector of a set of characteristics of the user, in which user similarity can be determined by computing a distance between vectors (e.g., a cosine similarity) corresponding to each user.

Another embodiment recommends one or more digital assets based on a performance objective or a goal. Some goals are inherent in the environment being simulated—for example, winning a match in a virtual tennis game. Other goals are user specified—for example, a user might specify a goal of being able to run fast, or run at a particular speed, in a simulated sports game. An embodiment generates a goal embedding, a vector representing a set of characteristics of the goal, and compares the goal embedding with one or more asset embeddings representing digital assets. The closer a goal embedding is to an asset embedding, the more likely that digital asset is to meet the goal. Thus the embodiment recommends one or more assets that are deemed likeliest to meet the goal.

Another embodiment recommends a sequence of digital assets based on a performance objective or a goal. Another embodiment iteratively recommends one or more digital assets based on a performance objective or a goal, with each iteration moving the user closer to the goal. Another embodiment recommends sharing a digital asset that another user is already using. For example, if no available asset achieves a sufficiently high score to be recommended, the embodiment determines that one or more asset embeddings being used by other users do achieve a sufficiently high score to be recommended. If one or more of those assets are marked as available for sharing, the embodiment recommends a shared asset. Alternatively, the embodiment requests that an asset be made available for sharing, either for free or in return for a payment.

An embodiment receives a user's selection of a digital asset to lease. If the lease has a non-zero price, one embodiment receives notification that the lease has been paid for. If the lease has a non-zero price, another embodiment processes payment for the lease.

An embodiment integrates the leased digital asset with a set of base characteristics of a virtualized user. To integrate a digital asset that is in image form (e.g. an item of virtual clothing), an embodiment uses a presently available technique, such a region-based convolutional neural network, to find bounding boxes for parts of the image, and uses the bounding boxes to extract portions of the image. Then the embodiment blends portions of the digital asset with corresponding portions of a visual representation of the user, or with corresponding portions of a user's avatar. To integrate a digital asset that is not in image form, an embodiment combines the asset with a baseline set of the user's existing characteristics. For example, if the asset is an ability to run at a particular speed faster than the user's baseline speed, an embodiment adjusts the user's running speed to the faster value.

An embodiment presents the integrated leased digital asset in a virtual environment during the time slot. In particular, if the digital asset is in image form, the digital asset is combined with the user's baseline visual representation. For example, if the digital asset is a virtual shirt, the user is presented as wearing the shirt in the virtual environment. If the digital asset is not in image form, the user is able to use the abilities, skills, or behaviors provided in the digital asset.

One embodiment ends a lease of a digital asset at the end of the assigned time slot. Another embodiment ends a lease of a digital asset once the performance objective has been met. When the lease ends, the user no longer has the visual representation or ability provided by the virtual asset.

The manner of leasing digital assets described herein is unavailable in the presently available methods in the technological field of endeavor pertaining to digital asset management and presentation. A method of an embodiment described herein, when implemented to execute on a device or data processing system, comprises substantial advancement of the functionality of that device or data processing system in determining a price for use of a digital asset, determining a time slot during which the digital asset is available for use, leasing out the digital asset at the price and during the time slot, integrating the leased digital asset with a set of base characteristics of a virtualized user, and presenting the integrated leased digital asset in a virtual environment during the time slot.

The illustrative embodiments are described with respect to certain types of digital assets, virtual environments, avatars, neural networks, embeddings, similarity measures, thresholds, time slots, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

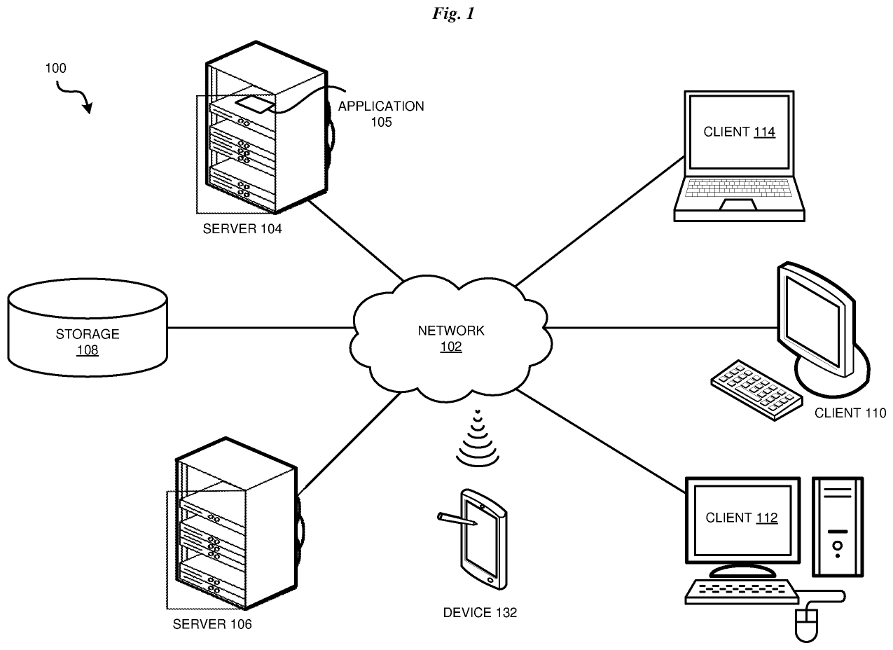

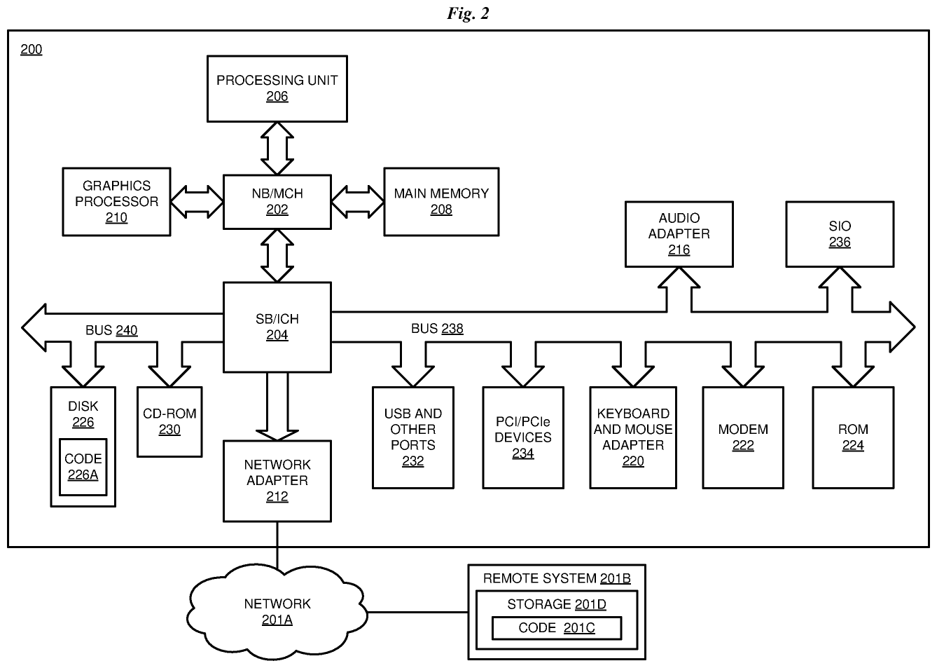

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132. Optionally, Application 105 presents a virtual environment in a different device from the device in which a remainder of application 105 executes.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as device 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

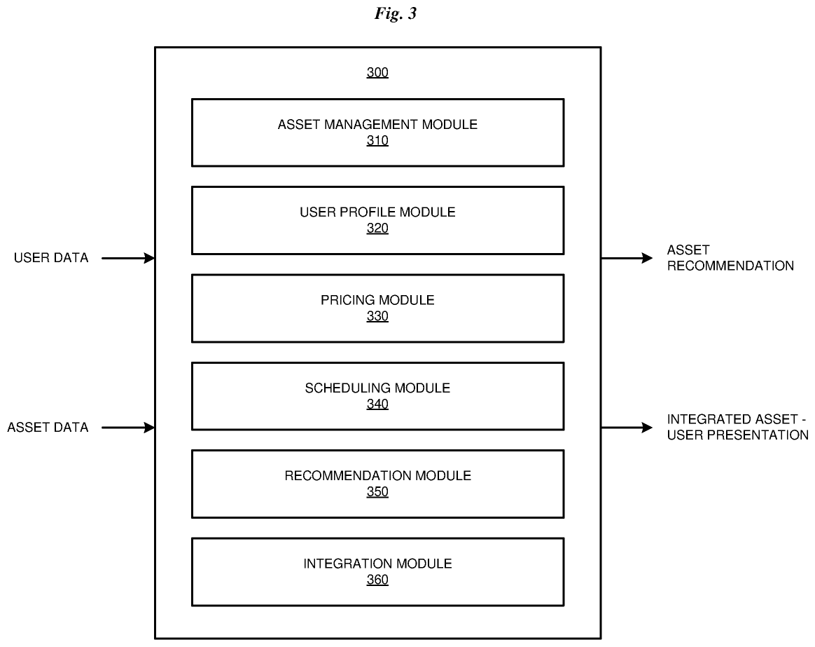

With reference to FIG. 3, this figure depicts a block diagram of an example configuration for leasing digital assets in accordance with an illustrative embodiment. Application 300 is an example of application 105 in FIG. 1 and executes in any of servers 104 and 106, clients 110, 112, and 114, and device 132 in FIG. 1.

Asset management module 310 manages a set of digital assets in a digital asset repository. Each digital asset includes the asset itself, as well as metadata pertaining to the asset. Some non-limiting examples of metadata pertaining to the asset are a lease or purchase price of the asset, a time period during which the asset is available for lease, a time period during which the asset is leased out and thus not available to others, data identifying an authorized user of the asset, how many copies of the asset exist, and contextual data describing a context in which the asset is to be used (e.g. data describing a technical conference at which the asset is to be virtually worn, or data identifying an electronic game in which the asset is to be used). Module 310 also manages transactions involving one or more digital assets in the digital asset repository, including transferring assets between users, transferring assets to another system external to the embodiment, creating, modifying, creating additional copies of, and deleting digital assets, and optionally performing payment processing for transactions involving managed digital assets. One implementation of module 310 modifies digital assets by combining multiple assets. For example, a virtual shirt and virtual pants can be combined into one virtual outfit. Another implementation of module 310 modifies digital assets by combining parts of multiple assets. For example, the virtual shirt within the virtual outfit can be combined with a virtual logo that is part of another virtual asset to create a new virtual shirt including the logo. One implementation of module 310 manages the set of digital assets using an NFT corresponding to each asset, and stores transaction data associated with an NFT on a blockchain.

User profile module 320 manages one or more user profiles in a user profile repository. A user profile includes a user's wallet, which includes data of the digital assets a user currently has access to, as well as data identifying the user. The digital assets a user currently has access to include any assets a user has purchased, any assets a user has leased (along with an expiration time of the lease), and any assets a user has fractional ownership of (along with the amount of fractional ownership). The user profile also includes optional additional data. One non-limiting example of data stored in a user profile is a history of digital assets the user has leased or purchased in the past, along with price data and usage times for each. Other non-limiting examples of data stored in a user profile are visual representation data (for use in integrating the user's visual representation with a digital asset), avatar data (for use in integrating the user's avatar with a digital asset), baseline skill, behavior, or ability data for the user or a character the user plays in a game or simulation, calendar or event data (for use in determining the user's upcoming events and which digital asset the user might be interested in using at an event), social media data (for use in determining the user's interests and events), payment data (for use in processing payment for a digital asset, accessory data (items the user was wearing or using in real-world or simulated interactions with others, used in determining the user's interests), and the like. For example, to generate three-dimensional visual representation data of a user, one presently available technique generates a three-dimensional scan from two-dimensional images of the user, generates a set of polygons corresponding to the three-dimensional scan, optimizes the set of polygons for implementation in a particular environment (based on processor speed, screen size, and the like), and adds texture detail. Presently available motion capture techniques are also usable to capture motions of the user, for use in animating a virtual version of the user.

Pricing module 330 determines a price for use of a digital asset in the digital asset repository. In one implementation of module 330, a price for use of a digital asset is predetermined. For example, in a fantasy game some digital assets might be free once a user has reached a predetermined level of the game, some virtual assets depicting virtual clothing might be priced at one dollar per day, and the only magic sword available in the game might be priced at a hundred dollars per hour of usage. Another implementation of module 330 uses a regression model, to predict a future price for use of a digital asset. A regression model estimates relationships between a dependent, output variable (here, a predicted price) and one or more independent, input variables. Some non-limiting examples of input variables are previous prices for digital assets, asset advertising data, promotions and other purchase or lease incentives on an asset, and contextual data of an asset. Contextual data of an asset is data regarding something else the asset is based on. For example, one digital asset in a virtual basketball game might be the virtual shirt of a real player in a real basketball league on which the virtual basketball game is based. The price of the virtual shirt can be expected to vary based on the real-world popularity of the real player. Depending on the input variables, an appropriate level of data aggregation by time (e.g. using weekly, monthly, or quarterly) data and geography (e.g., a particular region or country) is selected for use in the regression model.

Scheduling module 340 determines a time slot during which the digital asset is available for use. One implementation of module 340 assigns time slots on a first-come, first served basis. In other words, the first user to request use of an asset gets the asset for a predetermined time period, or a requested time period, while other users who want to lease the asset must select different times or wait until the first user's lease has expired. Another implementation of module 340 attempts to optimize multiple users' use of a digital asset by treating asset scheduling as a Traveling Salesman Problem with Time Windows (TSPTW) problem.

Recommendation module 350 recommends a digital asset to a user for lease or purchase. In one implementation of module 350, the recommendation includes a price for the asset. In another implementation of module 350, the recommendation includes a time slot during which the asset is available. In another implementation of module 350, the recommendation includes both a time slot and a price for leasing the asset during the time slot. One implementation of module 350 recommends one or more digital assets in response to a search query, such as a query for a virtual shirt with a particular logo or an ability to run in a virtual environment faster than a baseline speed.

Another implementation of module 350 recommends one or more digital assets using a collaborative filtering technique, which identifies a set of other users with one or more characteristics having more than a threshold amount of similarity with the user for whom an asset is being recommended, determines which assets the set of other users has purchased or leased, and uses characteristics of those assets to produce a set of recommended assets, or a ranked set of recommended assets, for the user. Collaborative filtering techniques are presently available.

Another implementation of module 350 recommends one or more digital assets using a content-based recommender system, which identifies characteristics of a user's past purchases or leases of digital assets, identifies one or more digital assets with characteristics above a threshold amount of similarity to the user's past purchases or leases, and uses those similarities to recommend a set of digital assets, or a ranked set of digital assets, to the user. To determine asset similarity, implementations of module 350 use presently known analysis techniques such as image to text decoding, term frequency, and inverse document frequency to determine an embedding corresponding to an asset. To determine user similarity, implementations of module 350 use presently known techniques, including term frequency, and inverse document frequency to determine an embedding corresponding to a user.

Another implementation of module 350 recommends one or more digital assets based on a performance objective or a goal. Module 350 generates a goal embedding, a vector representing a set of characteristics of the goal, and compares the goal embedding with one or more asset embeddings representing digital assets. The closer a goal embedding is to an asset embedding, the more likely that digital asset is to meet the goal. Thus module 350 recommends one or more assets that are deemed likeliest to meet the goal.

Another implementation of module 350 recommends a sequence of digital assets based on a performance objective or a goal. Another implementation of module 350 iteratively recommends one or more digital assets based on a performance objective or a goal, with each iteration moving the user closer to the goal. Another implementation of module 350 recommends sharing a digital asset that another user is already using. For example, if no available asset achieves a sufficiently high score to be recommended, the implementation determines that one or more asset embeddings being used by other users do achieve a sufficiently high score to be recommended. If one or more of those assets are marked as available for sharing, the implementation recommends a shared asset. Alternatively, the implementation requests that an asset be made available for sharing, either for free or in return for a payment.

Integration module 360 receives a user's selection of a digital asset to lease. If the lease has a non-zero price, one embodiment receives notification that the lease has been paid for. If the lease has a non-zero price, another embodiment processes payment for the lease.

Integration module 360 integrates the leased digital asset with a set of base characteristics of a virtualized user. To integrate a digital asset that is in image form (e.g. an item of virtual clothing), module 360 uses a presently available technique, such a region-based convolutional neural network, to find bounding boxes for parts of the image, and uses the bounding boxes to extract portions of the image. Then module 360 blends portions of the digital asset with corresponding portions of a visual representation of the user, or with corresponding portions of a user's avatar. To integrate a digital asset that is not in image form, module 360 combines the asset with a baseline set of the user's existing characteristics. For example, if the asset is an ability to run at a particular speed faster than the user's baseline speed, module 360 adjusts the user's running speed to the faster value.

Integration module 360 presents the integrated leased digital asset in a virtual environment during the time slot. In particular, if the digital asset is in image form, the digital asset is combined with the user's baseline visual representation. For example, if the digital asset is a virtual shirt, the user is presented as wearing the shirt in the virtual environment. If the digital asset is not in image form, the user is able to use the abilities, skills, or behaviors provided in the digital asset.

One implementation of module 360 ends a lease of a digital asset at the end of the assigned time slot. Another implementation of module 360 ends a lease of a digital asset once the performance objective has been met. When the lease ends, the user no longer has the visual representation or ability provided by the virtual asset.

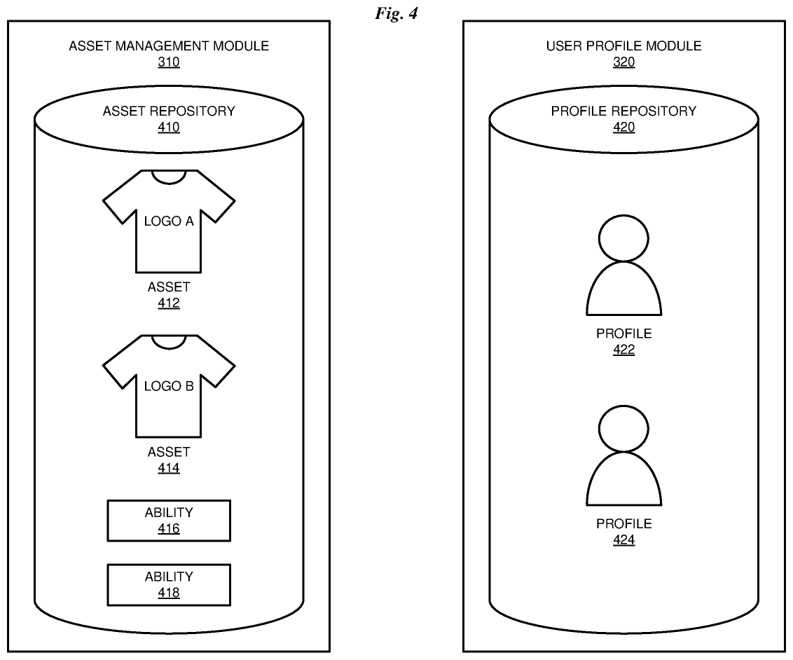

With reference to FIG. 4, this figure depicts an example of leasing digital assets in accordance with an illustrative embodiment. The example can be executed using application 300 in FIG. 3. Asset management module 310 and user profile module 320 are the same as asset management module 310 and user profile module 320 in FIG. 3.

Asset management module 310 manages asset repository 410. Asset repository 410 includes asset 412, a virtual shirt with a logo, asset 414, a virtual shirt with a different logo, and abilities 416 and 418. User profile module 320 manages profile repository 420, which includes user profiles 422 and 424.

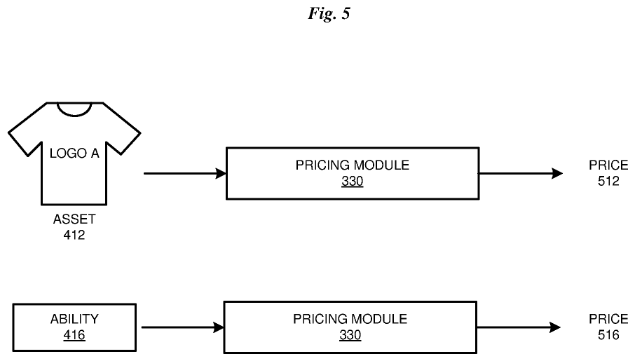

With reference to FIG. 5, this figure depicts a continued example of leasing digital assets in accordance with an illustrative embodiment. Pricing module 330 is the same as pricing module 330 in FIG. 3. Asset 412 and ability 416 are the same as asset 412 and ability 416 in FIG. 4.

Pricing module 330 determines a price for use of asset 412, generating price 512. Pricing module 330 also determines a price for use of ability 416, generating price 516.

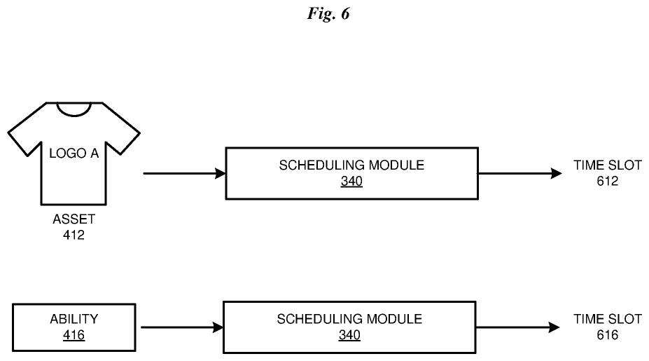

With reference to FIG. 6, this figure depicts a continued example of leasing digital assets in accordance with an illustrative embodiment. Scheduling module 340 is the same as scheduling module 340 in FIG. 3. Asset 412 and ability 416 are the same as asset 412 and ability 416 in FIG. 4.

Scheduling module 340 determines a time slot during which asset 412 is available for use, generating time slot 612. Scheduling module 340 determines a time slot during which ability 416 is available for use, generating time slot 616.

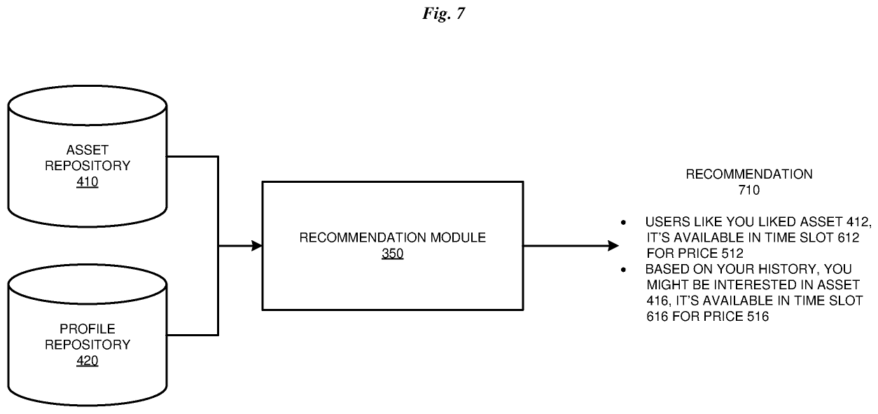

With reference to FIG. 7, this figure depicts a continued example of leasing digital assets in accordance with an illustrative embodiment. Recommendation module 350 is the same as recommendation module 350 in FIG. 3. Asset repository 410, profile repository 420, asset 412, and ability 416 are the same as asset repository 410, profile repository 420, asset 412, and ability 416 in FIG. 4. Prices 512 and 516 are the same as prices 512 and 516 in FIG. 5. Time slots 612 and 616 are the same as time slots 612 and 616 in FIG. 6.

Recommendation module 350 produces recommendation 710, recommending asset 412 and ability 416 to a user for lease or purchase and including price and time slot information.

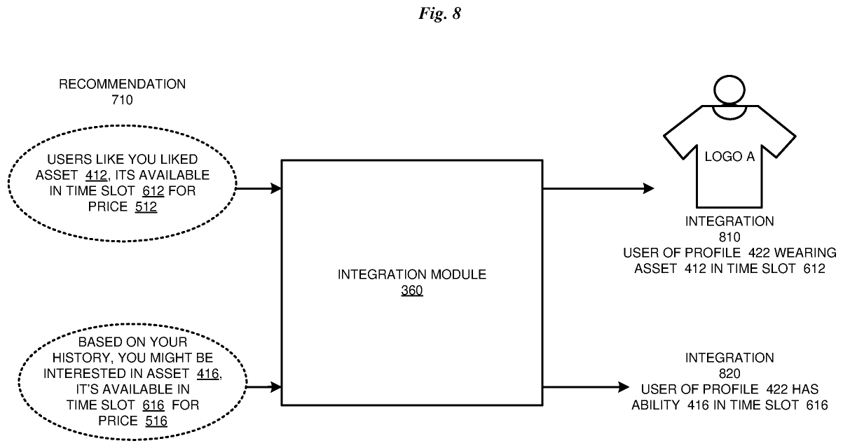

With reference to FIG. 8, this figure depicts a continued example of leasing digital assets in accordance with an illustrative embodiment. Integration module 360 is the same as integration module 360 in FIG. 3. Asset repository 410, profile repository 420, asset 412, ability 416, and profile 422 are the same as asset repository 410, profile repository 420, asset 412, ability 416, and profile 422 in FIG. 4. Prices 512 and 516 are the same as prices 512 and 516 in FIG. 5. Time slots 612 and 616 are the same as time slots 612 and 616 in FIG. 6. Recommendation 710 is the same as recommendation 710 in FIG. 7.

As depicted, the user of profile 422 has accepted recommendation 710. Thus, integration module 360 generates integrations 810 and 820, and presents them in a virtual environment during the time slot.

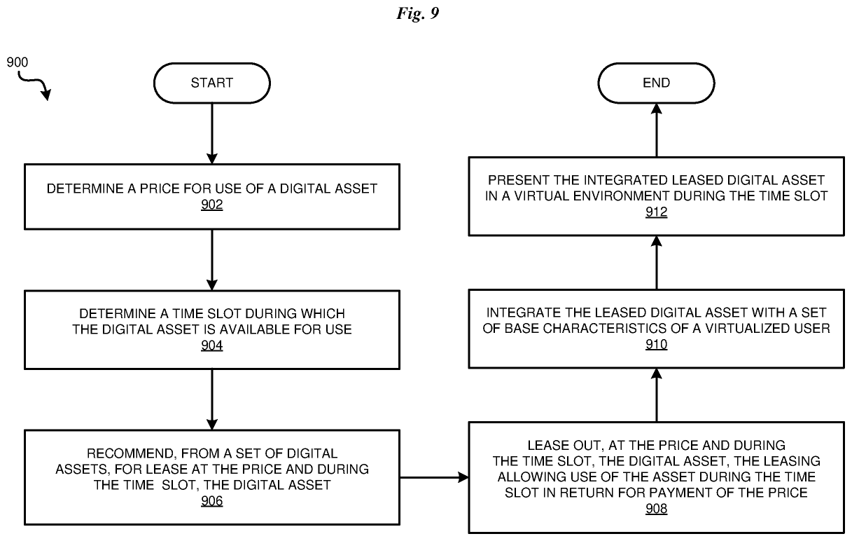

With reference to FIG. 9, this figure depicts a flowchart of an example process for leasing digital assets in accordance with an illustrative embodiment. Process 900 can be implemented in application 300 in FIG. 3.

In block 902, the application determines a price for use of a digital asset. In block 904, the application determines a time slot during which the digital asset is available for use. In block 906, the application recommends, from a set of digital assets, for lease at the price and during the time slot, the digital asset. In block 908, the application leases out, at the price and during the time slot, the digital asset, the leasing allowing use of the asset during the time slot in return for payment of the price. In block 910, the application integrates the leased digital asset with a set of base characteristics of a virtualized user. In block 912, the application presents the integrated leased digital asset in a virtual environment during the time slot. Then the application ends.

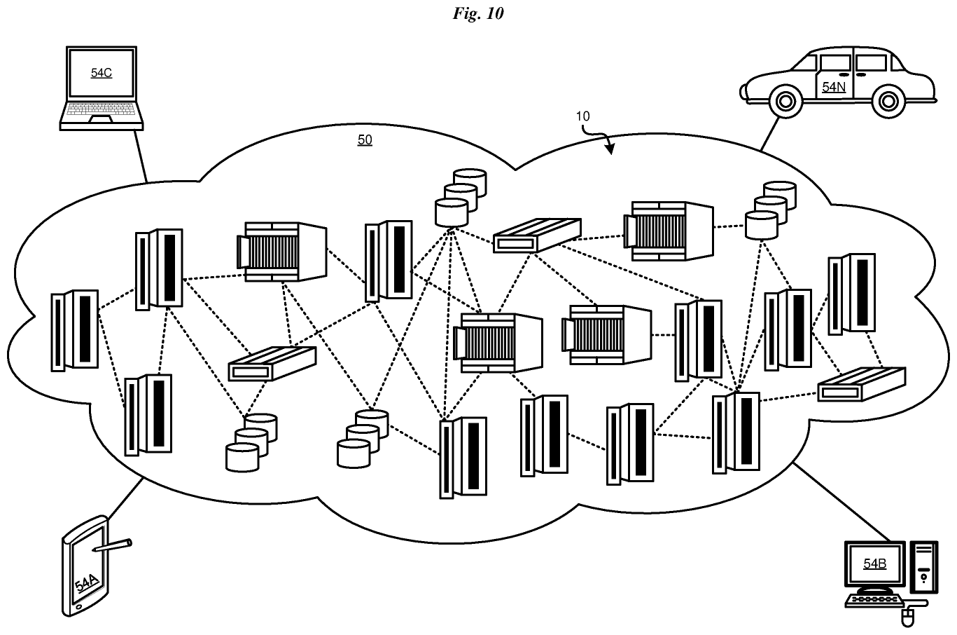

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

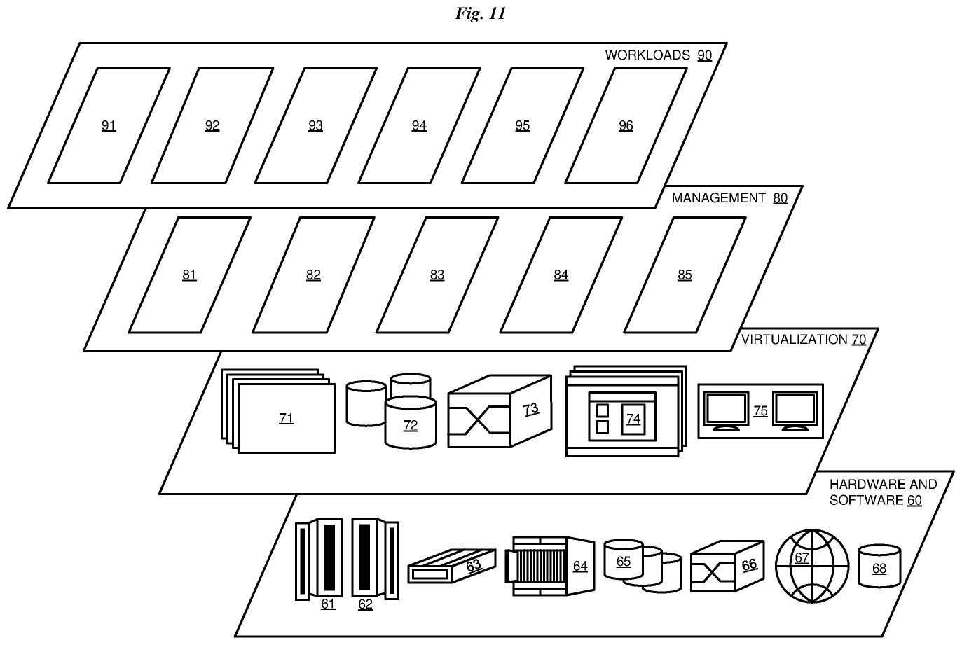

Referring now to FIG. 11, a set of functional abstraction layers provided by cloud computing environment 50 (FIG. 10) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for leasing digital assets and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
determining a price for use of a digital asset in a set of digital assets, the set of digital assets stored in a digital asset repository;
determining a time slot during which the digital asset is available for use;
leasing out, at the price and during the time slot, the digital asset, the leasing allowing use of the digital asset during the time slot in return for payment of the price, the leasing resulting in a leased digital asset;
integrating, with a set of base characteristics of a virtualized user, the leased digital asset, the integrating resulting in an integrated leased digital asset; and
presenting, in a virtual environment during the time slot, the integrated leased digital asset.

2. The computer-implemented method of claim 1, wherein the price for use of the digital asset is determined using a regression model predicting a future price for use of the digital asset.

3. The computer-implemented method of claim 1, wherein the time slot is determined using a time scheduling model implemented as a quadratic unconstrained binary optimization problem.

4. The computer-implemented method of claim 1, further comprising:
recommending, from the set of digital assets, for lease at the price and during the time slot, the digital asset.

5. The computer-implemented method of claim 4, wherein the recommending is based on a plurality of digital assets previously leased by a plurality of users.

6. The computer-implemented method of claim 4, wherein the recommending is based on a leasing history of a user to which the digital asset is leased out.

7. The computer-implemented method of claim 1, wherein the digital asset is used exclusively by the virtualized user during the time slot.

8. The computer-implemented method of claim 1, wherein the digital asset is used by the virtualized user and a second virtualized user during at least a portion of the time slot.

9. The computer-implemented method of claim 1, wherein the digital asset comprises a virtualized ability of the virtualized user.

10. The computer-implemented method of claim 1, wherein the digital asset comprises an appearance of the virtualized user.

11. The computer-implemented method of claim 1, wherein the digital asset comprises an audio characteristic of the virtualized user.

12. A computer program product for leasing a digital asset, the computer program product comprising:
one or more computer readable storage media, and program instructions collectively stored on the one or more computer readable storage media, the stored program instructions comprising:
program instructions to determine a price for use of the digital asset in a set of digital assets, the set of digital assets stored in a digital asset repository;
program instructions to determine a time slot during which the digital asset is available for use;
program instructions to lease out, at the price and during the time slot, the digital asset, the leasing allowing use of the digital asset during the time slot in return for payment of the price, the leasing resulting in a leased digital asset;
program instructions to integrate, with a set of base characteristics of a virtualized user, the leased digital asset, the integrating resulting in an integrated leased digital asset; and
program instructions to present, in a virtual environment during the time slot, the integrated leased digital asset.

13. The computer program product of claim 12, wherein the price for use of the digital asset is determined using a regression model predicting a future price for use of the digital asset.

14. The computer program product of claim 12, wherein the time slot is determined using a time scheduling model implemented as a quadratic unconstrained binary optimization problem.

15. The computer program product of claim 12, the stored program instructions further comprising:
program instructions to recommend, from the set of digital assets, for lease at the price and during the time slot, the digital asset.

16. The computer program product of claim 15, wherein the recommending is based on a plurality of digital assets previously leased by a plurality of users.

17. The computer program product of claim 12, wherein the stored program instructions are stored in the at least one of the one or more storage media of a local data processing system, and wherein the stored program instructions are transferred over a network from a remote data processing system.

18. The computer program product of claim 12, wherein the stored program instructions are stored in the at least one of the one or more storage media of a server data processing system, and wherein the stored program instructions are downloaded over a network to a remote data processing system for use in a computer readable storage device associated with the remote data processing system.

19. The computer program product of claim 12, wherein the computer program product is provided as a service in a cloud environment.

20. A computer system comprising one or more processors, one or more computer-readable memories, and one or more computer-readable storage media, and program instructions stored on at least one of the one or more storage media for execution by at least one of the one or more processors via at least one of the one or more memories, the stored program instructions comprising:
program instructions to determine a price for use of the digital asset in a set of digital assets, the set of digital assets stored in a digital asset repository;
program instructions to determine a time slot during which the digital asset is available for use;
program instructions to lease out, at the price and during the time slot, the digital asset, the leasing allowing use of the digital asset during the time slot in return for payment of the price, the leasing resulting in a leased digital asset;
program instructions to integrate, with a set of base characteristics of a virtualized user, the leased digital asset, the integrating resulting in an integrated leased digital asset; and
program instructions to present, in a virtual environment during the time slot, the integrated leased digital asset.
